(19) United States
(12) Patent Application Publication
(10) Pub. No.: US 2024/0370368 A1
(43) Pub. Date: Nov. 7, 2024

(54) METHOD FOR OPTIMIZING LOGICAL-TO-PHYSICAL TABLE UPDATES FOR FIXED GRANULARITY LOGICAL-TO-PHYSICAL TABLES

(71) Applicant: WESTERN DIGITAL TECHNOLOGIES, INC., San Jose, CA (US)

(72) Inventor: Kalpit Bordia, Bengaluru (IN)

(73) Assignee: WESTERN DIGITAL TECHNOLOGIES, INC., San Jose, CA (US)

(21) Appl. No.: 18/237,301

(22) Filed: Aug. 23, 2023

Related U.S. Application Data
(60) Provisional application No. 63/463,754, filed on May 3, 2023.

(51) Int. Cl. G06F 12/02

(52) U.S. Cl. CPC G06F 12/0292; G06F 12/0246; G06F 2212/7201

(57) ABSTRACT

Performance on a storage device may be improved when executing a write command with sequential host data. The storage device optimizes logical-to-physical table updates for fixed granularity logical-to-physical tables that are populated when writing the sequential host data. A host interface module on the storage device may receive, from a host, a command to store the host data on a memory device and classify the host data as sequential host data or random host data. A flash translation layer on the storage device predetermines open contiguous blocks on the memory device where the sequential host data is to be written and provides a beginning address of the open contiguous blocks to the host interface module. The host interface module populates an address translation table with logical-to-physical mappings starting at the beginning address with an appropriate offset. Each entry in the address translation table corresponds to a fixed granularity.

### CROSS-REFERENCE TO RELATED APPLICATION

The present application claims the benefit of U.S. Provisional Application Ser. No. 63/463,754 titled “METHOD FOR OPTIMIZING LOGICAL-TO-PHYSICAL TABLE UPDATES FOR FIXED GRANULARITY LOGICAL-TO-PHYSICAL TABLES,” filed May 3, 2023, which is incorporated by reference herein in its entirety.

### BACKGROUND

A host may transmit a command to read data from and/or write data to, for example, a flash memory device coupled to a storage device. A controller on the storage device may include a host interface module that may interact with the host. When the storage device receives a command from the host, the host interface module may determine if the command is, for example, a write command, a read command, or an administration command.

When the host interface module receives a write command, the host interface module may perform stream classification, wherein the host interface module may determine if the host data is to be written to the memory device in a sequential format or in a random format. Host data written in the sequential format (referred to herein as sequential host data) may be stored in contiguous blocks in the memory device and host data written in the random format (referred to herein as random host data) may be stored in non-contiguous blocks in the memory device. The host interface module may also perform chunking on the data, wherein the host interface module may break up or accumulate the host data into uniform-sized chunks before sending the data to the memory device. For example, depending on the configuration of the storage device, the host interface module may break up the host data into chunks of, for example, 4 KB, 8 KB, 16 KB, 32 KB, etc., or, if the size of the host data is smaller than the set chunk size, the host interface module may accumulate the host data, before sending the data to the memory device, until the data reaches the chunk size. After performing stream classification and chunking, the host interface module may transfer the host data to a random-access memory on the storage device.

A flash translation layer on the storage device may route the host data from the random-access memory to the memory device by, for example, determining where the data will be stored on the memory device. For example, the flash translation layer may determine the contiguous blocks on the memory device where sequential host data will be stored and blocks (contiguous and/or non-contiguous block) on the memory device where random host data may be stored. The flash translation layer may map logical addresses associated with the host data to physical addresses in the memory device and store the mapping information in a logical-to-physical table. The flash translation layer may transmit the data to a back-end layer that is communicatively coupled to the memory device, wherein the data may be stored at the physical addresses on the memory device. While the data is being stored on the memory device, the flash translation layer may update a single address translation table with logical-to-physical mappings, complete the write operation, and release the necessary buffer.

The current write flow is linear and bottlenecks may occur because of the write speed of the memory device when the flash translation layer transmits the data to the memory device. Bottlenecks may also occur because of the speed at which a flash interface module can transfer data from the controller on the storage device to the memory device. As technologies improve the write speed of the memory device and the speed at which the flash interface module can transfer data from the controller to the memory device may also improve. As these speeds improve, bottlenecks on the storage device in writing the host data may occur because of processing at the flash translation layer.

### SUMMARY

In some implementations, the storage device is communicatively coupled to a host device that transmits write commands to store data on a memory device. The storage device may include the memory device to store data and a processor including a host interface module and a flash translation layer. The host interface module may receive, from the host device, a command to store host data on the memory device and classify the host data as sequential host data or random host data. The flash translation layer predetermines open contiguous blocks on the memory device where sequential host data is to be written and provides a beginning address of the open contiguous blocks to the host interface module. The host interface module utilizes this pre-determined block address to populate parts of an address translation table with logical-to-physical mappings starting at the beginning address with an appropriate offset, where each entry in the address translation table corresponds to a fixed granularity.

In some implementations, a method is provided to improve performance on a storage device implementing a write command for sequential host data. The method includes receiving, by the storage device from the host device, a command to store host data on the memory device and classifying the host data as sequential host data or random host data. The method also includes predetermining, by the storage device, open contiguous blocks on the memory device where sequential host data is to be written. Prior to transmitting the sequential host data to the memory device, the method includes populating, by the storage device, parts of an address translation table with logical-to-physical mappings starting at the beginning address with an appropriate offset, where each entry in the address translation table corresponds to a fixed granularity.

In some implementations, the flash translation layer may predetermine open contiguous blocks on the memory device where sequential host data is to be written and obtain a beginning address of the open contiguous blocks. A processor on the storage device may retrieve the beginning address and populate parts of an address translation table with logical-to-physical mappings starting at the beginning address with an appropriate offset, where each entry in the address translation table corresponds to a fixed granularity.

### BRIEF DESCRIPTION OF THE SEVERAL VIEWS OF THE DRAWINGS

FIG. 1 is a schematic block diagram of an example system in accordance with some implementations.

FIG. 2 is an example of a single address translation table in accordance with some implementations.

FIGS. 3A-1 and 3A-2 are flow diagrams of an example process for improving performance on a storage device implementing a write command for sequential host data by optimizing logical-to-physical table updates for fixed granularity logical-to-physical tables in accordance with some implementations.

FIG. 4 is a diagram of an example environment in which systems and/or methods described herein are implemented.

FIG. 5 is a diagram of example components of the host of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

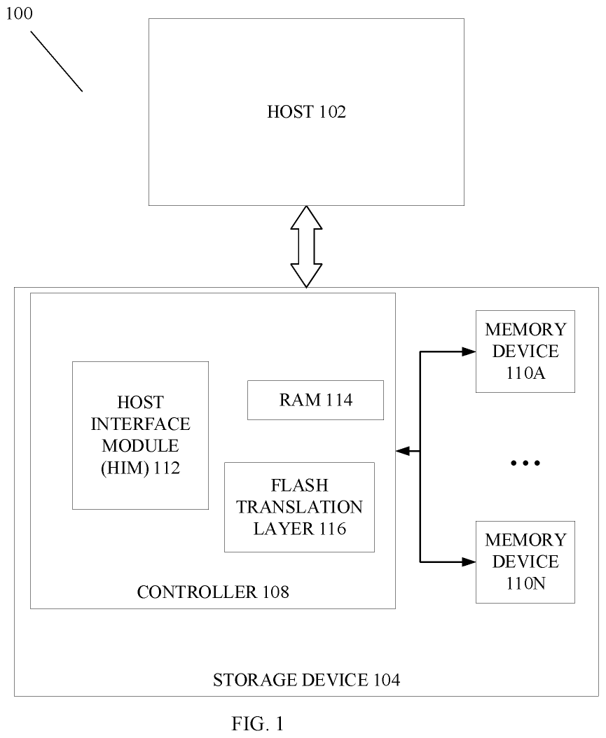

FIG. 1 is a schematic block diagram of an example system in accordance with some implementations. System 100 includes a host 102 and a storage device 104. Host 102 may transmit commands to read or write data to storage device 104. Host 102 and storage device 104 may be in the same physical location as components on a single computing device or on different computing devices that are communicatively coupled. Storage device 104, in various embodiments, may be disposed in one or more different locations relative to the host 102. Host 102 may include additional components (not shown in this figure for the sake of simplicity).

Storage device 104 may include a controller 108 with a host interface module (HIM) 112, a random-access memory (RAM) 114, and a flash translation layer 116. Storage device 104 may also include one or more memory devices 110a-110n (referred to herein as memory device(s) 110). Storage device 104 may be, for example, a solid-state drive (SSD), and the like. Memory device 110 may be flash based, including, for example, NAND flash memory. Memory device 110 may be included in storage device 104 or may be otherwise communicatively coupled to storage device 104.

Controller 108 may execute background operations to manage resources on memory device 110. For example, controller 108 may monitor memory device 110 and may execute garbage collection and other relocation functions per internal relocation algorithms to refresh and/or relocate the data on memory device 110. Controller 108 may also process foreground operations including instructions transmitted from host 102. For example, controller 108 may read data from and/or write data to memory device 110 based on instructions received from host 102.

Host interface module 112 may interface with host 102 and may receive commands and data from host 102. When host 102 transmits a command to storage device 104, host interface module 112 may receive the command and determine if the command is, for example, a write command, a read command, or an administration command. If the command received from host 102 is a write command, host interface module 112 may perform stream classification and determine if the data is to be written to memory device 110 in a sequential format or in a random format. Host data written in the sequential format (referred to herein as sequential host data) may be stored in contiguous blocks in memory device 110 and host data written in the random format (referred to herein as random host data) may be stored in contiguous and/or non-contiguous blocks in memory device 110.

Host interface module 112 may also perform chunking on the host data and may break up or accumulate the host data into uniform-sized chunks before sending the data to memory device 110. Exemplary chunk sizes may be 4K, 8K, 16K, 32K bytes, etc. In an example where host interface module 112 breaks up or accumulates the host data into 4 KB chunks, when host interface module 112 receives a write command with 512 KB data from host 102, host interface module 112 may break up the 512 KB data into 128 4 KB chunks. If the size of the host data is smaller than 4 KB, host interface module 112 may accumulate the host data, before sending the data to memory device 110, until the data size reaches 4 KB.

After performing stream classification and chunking, host interface module 112 may transfer the host data associated with the write command to RAM 114. Host interface module 112 may also send a message for the host data to flash translation layer 116. Flash translation layer 116 may determine how the host data may be routed and stored on memory device 110.

For sequential host data, flash translation layer 116 may predetermine open contiguous blocks on memory device 110 where the sequential host data may be written. Flash translation layer 116 may identify the beginning of the open contiguous blocks on memory device 110 where the sequential host data may be stored and may also obtain a pointer/address for the beginning of the open blocks (referred to herein as a jumbo block address (BA). Flash translation layer 116 may also determine the ending address of the open contiguous blocks, wherein with the beginning and ending address, the size of the open contiguous blocks may be determined.

Flash translation layer 116 may store the jumbo block address such that host interface module 112 or another auxiliary processor (referred to herein as HIM 112/auxiliary processor) on controller 108 may obtain the jumbo block address. Flash translation layer 116 may also make the address associated with the ending of the open contiguous blocks accessible to HIM 112/auxiliary processor. With the beginning and ending addresses of the open contiguous blocks, HIM 112/auxiliary processor may determine the size of the open contiguous blocks.

When host interface module 112 identifies a write command, host interface module 112 may determine the size of the host data associated with the write command. Based on the size of sequential host data stored in RAM 114 and the size of the open contiguous blocks pointed to by the jumbo block address, HIM 112/auxiliary processor may populate a part of the single address translation table 200 with logical-to-physical mappings. The logical-to-physical mappings may map the logical addresses associated with the sequential host data to physical addresses in memory device 110, starting at the jumbo block address with an appropriate offset, wherein each entry represents a fixed granularity.

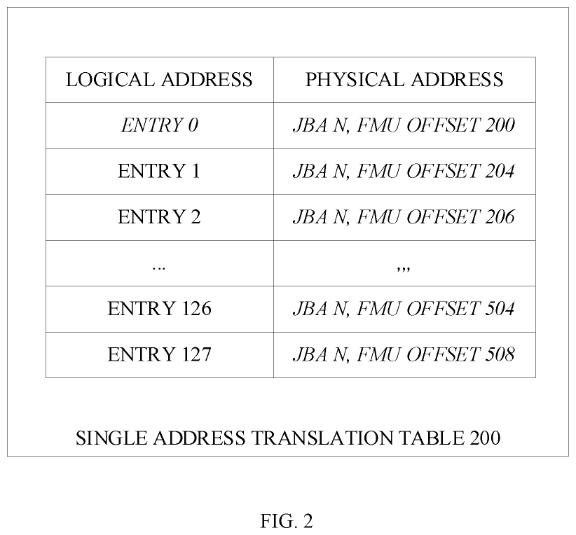

Consider an example where host 102 issues a command to write 512 KB data to memory device 110. Host interface module 112 may divide the sequential host data into 4 KB chunks (such that the data is referred to herein as having a fixed granularity of 4 KB). Based on this configuration, as host interface module 112 is receiving the sequential host data, HIM 112/auxiliary processor may populate 128 entries (i.e., 512/4) in a single address translation table 200. If flash translation layer 116 allocates a sequential stream block N for a typical path and determines that the current open block pointer is at a flash management unit (FMU) offset 200, wherein each block is made up of a fixed number of FMUs, HIM 112/auxiliary processor may populate single address translation table 200 with logical-to-physical mappings, starting at JBA N, FMU offset 200, as shown in FIG. 2. If, in other examples (not shown), the data has a fixed granularity of 8 KB, HIM 112/auxiliary processor may populate 64 entries in the single address translation table 200, if the data has a fixed granularity of 16 KB, HIM 112/auxiliary processor may populate 32 entries in the single address translation table 200, and so on.

HIM 112/auxiliary processor may transmit the populated single address translation table 200 or a pointer to the populated single address translation table 200 to flash translation layer 116. The flash translation layer 116 may transmit the sequential host data to a back-end layer that is communicatively coupled to memory device 110, wherein the sequential host data may be written to the physical addresses on memory device 110 corresponding to the physical mappings in the single address translation table 200.

While the data is being transferred to and stored on memory device 110, flash translation layer 116 may determine if single address translation table 200 has been populated by HIM 112/auxiliary processor. If single address translation table 200 has been populated, flash translation layer 116 may perform a fast update via, for example, a direct memory access transfer or by copying single address translation table 200 to an appropriate location and completing the write for processing for that write command.

In some implementations, HIM 112/auxiliary processor may not populate single address translation table 200 with logical-to-physical mappings for the sequential host data. For example, if HIM 112/auxiliary processor determines that the remaining space available in the open contiguous blocks in memory device 110 is smaller than the size of the sequential host data, HIM 112/auxiliary processor may not populate single address translation table 200. HIM 112/auxiliary processor may notify flash translation layer 116 when HIM 112/auxiliary processor does not populate single address translation table 200. In some implementations, when HIM 112/auxiliary processor notifies flash translation layer 116 that single address translation table 200 is not updated because of lack of available space in the current open contiguous blocks, flash translation layer 116 may update where the sequential host data may be routed by updating the jumbo block address. If based on the updated jumbo block address HIM 112/auxiliary processor determines that the remaining space available in the open contiguous blocks in memory device 110 is larger than the size of the sequential host data, HIM 112/auxiliary processor may populate single address translation table 200.

In another example, if HIM 112/auxiliary processor determines that the host data is not sequential data, HIM 112/auxiliary processor may not update single address translation table 200 with logical-to-physical mappings for the host data. HIM 112/auxiliary processor may notify flash translation layer 116 that the single address translation table 200 is not populated.

When HIM 112/auxiliary processor does not update the single address translation table 200, flash translation layer 116 may perform data routing and determine how the data may be stored on open blocks on memory device 110. For example, as flash translation layer 116 transmits the host data to the back-end layer for further transfer to memory device 110 where the data may be stored, flash translation layer 116 may map the logical addresses associated with the host data to the physical addresses in memory device 110. Flash translation layer 116 may store the mapping information in single address translation table 200 and release the necessary buffer.

When single address translation table 200 is updated either by HIM 112/auxiliary processor or flash translation layer 116 as a part of every write operation performed, the current open block pointer may be updated to reflect the same. Hence, once a write operation is performed, the open block pointer would be updated by HIM 112/auxiliary processor and flash translation layer 116 to be in sync. Consider an example where Block A offset 100 is the current address (address 100 being the next location in Block A to store sequential host data). If host interface module 112 receives 32 KB sequential host data and determines that the update granularity is 4 KB, HIM 112/auxiliary processor or flash translation layer 116 may update eight entries in single address translation table 200. Before the write operation is performed, the open block address to be used by HIM 112/auxiliary processor or flash translation layer 116 will be A, offset 100. After the write is performed, HIM 112/auxiliary processor and flash translation layer 116 may update the open block address, such that the updated open block address with HIM 112/auxiliary processor and flash translation layer 116, will be A, offset 108 (because offsets 100, 101, 102, 103, 104, 105, 106, 107 would have been used for the eight entries associated with the sequential host data stored during the write operation and offset 108 would be the next available location to write the sequential host data).

Entries in single address translation table 200 may be updated at a fixed granularity. In an example where the data has a fixed granularity of 4 KB and where 4B of data is used to address the 4 KB of sequential host data in single address translation table 200, an entry for each 4 KB of data may be updated in single address translation table 200. Therefore, for a 64 KB chunk of sequential host data, sixteen entries in single address translation table 200 may be updated, for a 128 KB chunk of sequential host data, thirty-two entries in single address translation table 200 may be updated, for a 256 KB chunk of sequential host data, sixty-four entries in single address translation table 200 may be updated, and so on. Updating single address translation table 200 at a fixed granularity may cause a bottleneck for storage device 104 throughput. Some implementations may thus improve the write performance on storage device 104 for sequential host data in cases where HIM 112/auxiliary processor can update single address translation table 200. The overall power consumption of storage device 104 may also be reduced due to less processing utilization during write flows when HIM 112/auxiliary processor updates single address translation table.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

FIGS. 3A-1 and 3A-2 are flow diagrams of an example process for improving performance on a storage device implementing a write command for sequential host data by optimizing logical-to-physical table updates for fixed granularity logical-to-physical tables in accordance with some implementations. At 310, host 102 may transmit a write command to storage device 104 and host interface module 112 may perform stream classification and chunking on the host data. At 320, host interface module 112 may transfer the host data associated with the write command to RAM 114 and send messages for the host data to flash translation layer 116. At 330, flash translation layer 116 may pre-determine how sequential host data may be routed and stored on memory device 110, determine the beginning and end of open contiguous blocks on memory device 110 where the sequential host data may be stored, and obtain a jumbo block address for the open contiguous blocks. At 340, flash translation layer 116 may store the jumbo block address such that HIM 112/auxiliary processor may access the jumbo block address.

At 350, when host interface module 112 is receiving the write command, host interface module 112 may determine the size of the host data. At 360, if the host data is classified as sequential host data, based on the size of the sequential host data and the remaining available space in the open contiguous blocks pointed to by the jumbo block address, HIM 112/auxiliary processor may populate parts of single address translation table 200 with logical-to-physical mappings, starting at the jumbo block address with the appropriate offset, where each entry in the address translation table corresponds to a fixed granularity.

At 370, HIM 112/auxiliary processor may transmit the populated single address translation table 200 or a pointer to the populated single address translation table 200 to flash translation layer 116 and update the current open block pointer. At 380, flash translation layer 116 may transmit the sequential host data to a back-end layer that is communicatively coupled to memory device 110, wherein the sequential host data may be written to physical addresses on memory device 110 that correspond with single address translation table 200.

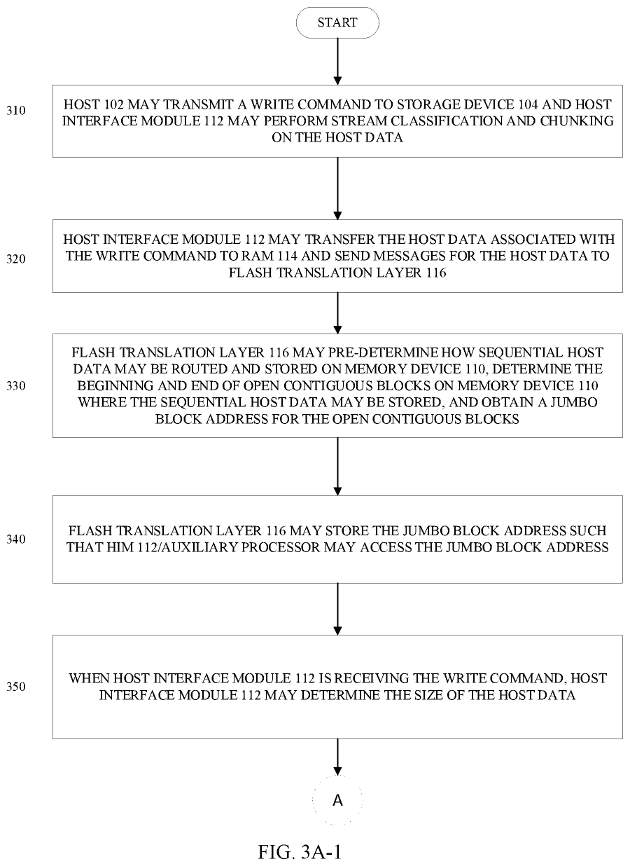

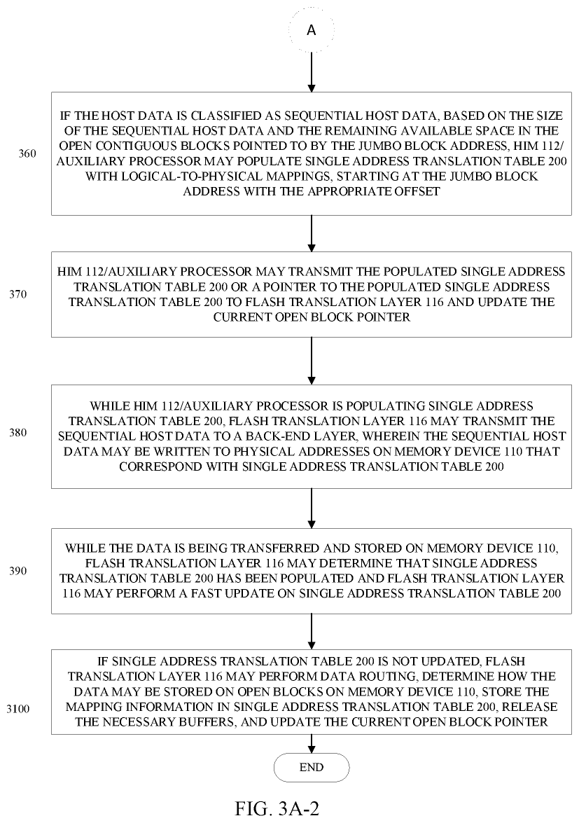

At 390, while the data is being transferred and stored on memory device 110, flash translation layer 116 may determine that single address translation table 200 has been populated and flash translation layer 116 may perform a fast update on single address translation table 200 and release the necessary buffers. At 3100, if single address translation table 200 is not updated, flash translation layer 116 may perform data routing, determine how the data may be stored on open blocks on memory device 110, store the mapping information in single address translation table 200, release the necessary buffers, and update the current open block pointer. As indicated above FIG. 3 is provided as an example. Other examples may differ from what is described in FIG. 3.

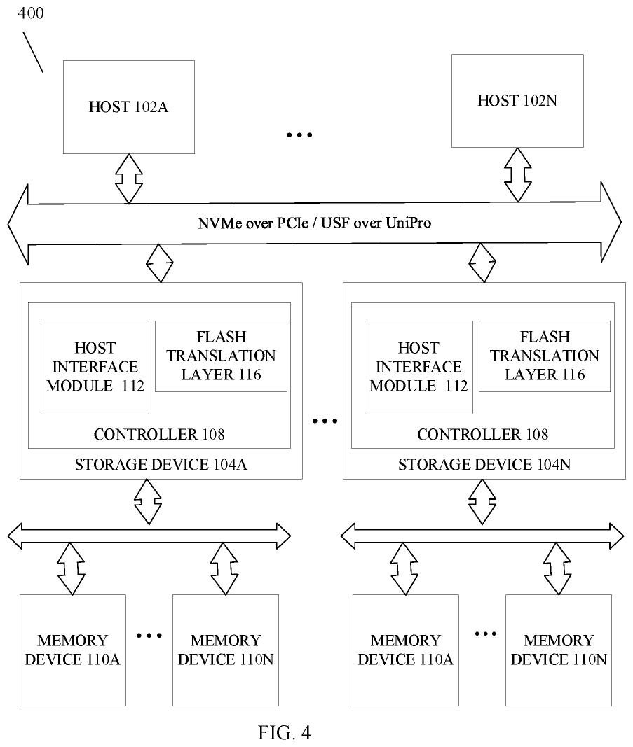

FIG. 4 is a diagram of an example environment in which systems and/or methods described herein are implemented. As shown in FIG. 4, Environment 400 may include hosts 102-102n (referred to herein as host(s) 102), and storage devices 104a-104n (referred to herein as storage device(s) 104).

Storage device 104 may include a controller 108 to manage the resources on storage device 104. Controller 108 may include a host interface module 112 and one or more auxiliary processors (not shown) to update a single address translation table with logical-to-physical mappings for sequential host data associated with a write command. Controller 108 may improve the performance of storage device 104 when writing sequential host data to memory device 110 by optimizing logical-to-physical table updates for fixed granularity logical-to-physical tables. Controller 108 may include also include a flash translation layer 116 to manage updates to the single address translation table. Hosts 102 and storage devices 104 may communicate via Non-Volatile Memory Express (NVMe) over peripheral component interconnect express (PCI Express or PCIe) standard, the Universal Flash Storage (UFS) over Unipro, or the like.

Devices of Environment 400 may interconnect via wired connections, wireless connections, or a combination of wired and wireless connections. For example, the network of FIG. 4 may include a cellular network (e.g., a long-term evolution (LTE) network, a code division multiple access (CDMA) network, a 3G network, a 4G network, a 5G network, another type of next-generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of Environment 400 may perform one or more functions described as being performed by another set of devices of Environment 400.

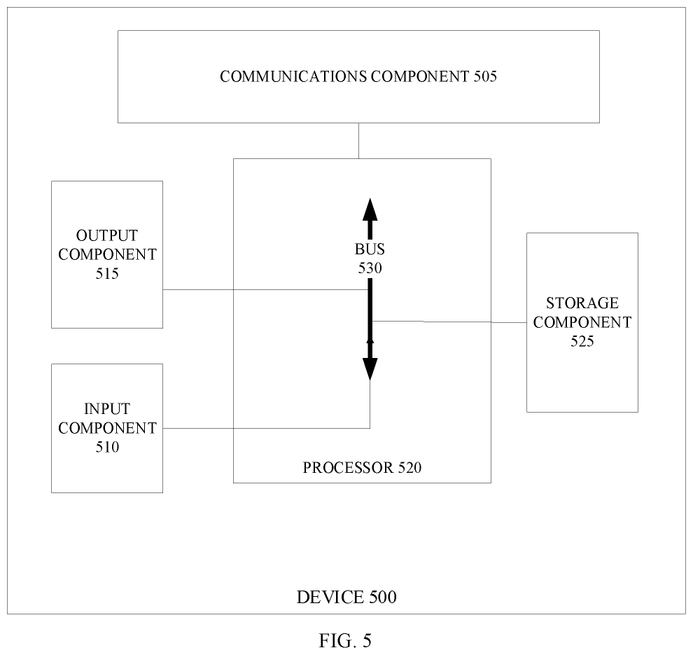

FIG. 5 is a diagram of example components of one or more devices of FIG. 1. In some implementations, host 102 may include one or more devices 500 and/or one or more components of device 500. Device 500 may include, for example, a communications component 505, an input component 510, an output component 515, a processor 520, a storage component 525, and a bus 530. Bus 530 may include components that enable communication among multiple components of device 500, wherein components of device 500 may be coupled to be in communication with other components of device 500 via bus 530.

Input component 510 may include components that permit device 500 to receive information via user input (e.g., keypad, a keyboard, a mouse, a pointing device, a microphone, and/or a display screen), and/or components that permit device 500 to determine the location or other sensor information (e.g., an accelerometer, a gyroscope, an actuator, another type of positional or environmental sensor). Output component 515 may include components that provide output information from device 500 (e.g., a speaker, display screen, and/or the like). Input component 510 and output component 515 may also be coupled to be in communication with processor 520.

Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 may include one or more processors capable of being programmed to perform a function. Processor 520 may be implemented in hardware, firmware, and/or a combination of hardware and software.

Storage component 525 may include one or more memory devices, such as random-access memory (RAM) 114, read-only memory (ROM), and/or another type of dynamic or static storage device (e.g., a flash memory, a magnetic memory, and/or optical memory) that stores information and/or instructions for use by processor 520. A memory device may include memory space within a single physical storage device or memory space spread across multiple physical storage devices. Storage component 525 may also store information and/or software related to the operation and use of device 500. For example, storage component 525 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, and/or another type of non-transitory computer-readable medium, along with a corresponding drive.

Communications component 505 may include a transceiver-like component that enables device 500 to communicate with other devices, such as via a wired connection, a wireless connection, or a combination of wired and wireless connections. The communications component 505 may permit device 500 to receive information from another device and/or provide information to another device. For example, communications component 505 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 505 may also include one or more broadband and/or narrowband transceivers and/or other similar types of wireless transceiver configurable to communicate via a wireless network for infrastructure communications. Communications component 505 may also include one or more local area network or personal area network transceivers, such as a Wi-Fi transceiver or a Bluetooth transceiver.

Device 500 may perform one or more processes described herein. For example, device 500 may perform these processes based on processor 520 executing software instructions stored by a non-transitory computer-readable medium, such as storage component 525. As used herein, the term “computer-readable medium” refers to a non-transitory memory device. Software instructions may be read into storage component 525 from another computer-readable medium or from another device via communications component 505. When executed, software instructions stored in storage component 525 may cause processor 520 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device communicatively coupled to a host device that transmits write commands to store data on a memory device, the storage device comprising:
a memory device to store data; and
a processor including a host interface module and a flash translation layer,
the host interface module to receive, from the host device, a command to store host data on the memory device and to classify the host data as one of sequential host data and random host data; and
the flash translation layer to predetermine open contiguous blocks on the memory device where sequential host data is to be written and provide a beginning address of the open contiguous blocks to the host interface module for the host interface module to populate an address translation table with logical-to-physical mappings starting at the beginning address with an appropriate offset, where each entry in the address translation table corresponds to a fixed granularity.

2. The storage device of claim 1, wherein while the flash translation layer transmits the sequential host data to be written to the memory device and the flash translation layer determines that the address translation table is populated, the flash translation layer performs a fast update to the address translation table and completes processing for the command.

3. The storage device of claim 1, wherein while the flash translation layer transmits the sequential host data to be written to the memory device and the flash translation layer determines that the address translation table is not populated, the flash translation layer performs logical-to-physical mappings, populates the address translation table, and completes processing for the command.

4. The storage device of claim 1, wherein the flash translation layer provides the beginning address and an ending address of the open contiguous blocks to the host interface module and the host interface module uses the beginning address and the ending address to determine a size of the open contiguous blocks.

5. The storage device of claim 4, wherein the host interface module does not populate the address translation table if the host interface module determines that remaining space available in the open contiguous blocks is smaller than the size of the sequential host data.

6. The storage device of claim 5, wherein the host interface module sends a message to the flash translation layer and the flash translation layer updates the beginning address, and wherein the host interface module populates the address translation table using an updated beginning address.

7. The storage device of claim 1, wherein the host interface module does not populate the address translation table if the host interface module determines that the host data is random host data.

8. The storage device of claim 1, wherein entries in the address translation table are updated at a fixed granularity.

9. The storage device of claim 1, wherein the logical-to-physical mappings map the logical addresses associated with the sequential host data to physical addresses in the memory device.

10. A method to improve performance on a storage device implementing a write command for sequential host data, the storage device having a memory to store data and a processor to process commands received from the host device, the method comprises:
receiving, by the storage device from the host device, a command to store host data on the memory device;
classifying, by the storage device, the host data as one of sequential host data and random host data;
predetermining, by the storage device, open contiguous blocks on the memory device where sequential host data is to be written and obtaining a beginning address of the open contiguous blocks; and
prior to transmitting the sequential host data to the memory device, populating, by the storage device, an address translation table with logical-to-physical mappings starting at the beginning address with an appropriate offset, where each entry in the address translation table corresponds to a fixed granularity.

11. The method of claim 10, further comprising while transmitting the sequential host data to be written to the memory device, determining that the address translation table is populated, performing a fast update to the address translation table, and completing processing for the command.

12. The method of claim 10, further comprising while transmitting the sequential host data to be written to the memory device, determining that the address translation table is not populated, performing logical-to-physical mappings, populating the address translation table, and completing processing for the command.

13. The method of claim 10, further comprising using the beginning address and an ending address to determine a size of the open contiguous blocks.

14. The method of claim 13, further comprising determining that remaining space available in the open contiguous blocks is smaller than the size of the sequential host data and not populating the address translation table.

15. The method of claim 14, further comprising updating the beginning address and populating the address translation table using an updated beginning address.

16. The method of claim 10, further comprising determining that the host data is random host data and not populating the address translation table.

17. The method of claim 10, further comprising updating entries in the address translation table at a fixed granularity.

18. A storage device communicatively coupled to a host device that transmits write commands to store data on a memory device, the storage device comprising:
a memory device to store data; and
a processor including a host interface module and a flash translation layer,
the host interface module to receive, from the host device, a command to store host data on the memory device and to classify the host data as one of sequential host data and random host data; and
the flash translation layer to predetermine open contiguous blocks on the memory device where sequential host data is to be written and obtain a beginning address of the open contiguous blocks; and
wherein the processor retrieves the beginning address and populates an address translation table with logical-to-physical mappings starting at the beginning address with an appropriate offset, where each entry in the address translation table corresponds to a fixed granularity.

19. The storage device of claim 18, wherein while the flash translation layer transmits the sequential host data to be written to the memory device and the flash translation layer determines that the address translation table is populated, the flash translation layer performs a fast update to the address translation table and completes processing for the command.

20. The storage device of claim 18, wherein while the flash translation layer transmits the sequential host data to be written to the memory device and the flash translation layer determines that the address translation table is not populated, the flash translation layer performs logical-to-physical mappings, populates the address translation table, and completes processing for the command.
